(19) United States
(12) Patent Application Publication
(10) Pub. No.: US 2006/0223899 A1
(43) Pub. Date: Oct. 5, 2006

(54) Removal of porogens and porogen residues using supercritical CO2

(76) Inventors: Joseph T. Hillman, Scottsdale, AZ (US); Robert Kevwitch, Chandler, AZ (US)

Correspondence Address: HAVERSTOCK & OWENS LLP, 162 NORTH WOLFE ROAD, SUNNYVALE, CA, 94086, US

(21) Appl. No.: 11/094,882

(22) Filed: Mar. 30, 2005

(51) Int. Cl. C08J 9/26

(52) U.S. Cl. 521/61

(57) ABSTRACT

A method of and apparatus for treating a substrate to remove porogens and/or porogen residues form a dielectric layer using a processing chamber operating at a supercritical state is disclosed. In addition, other supercritical processes can be performed before and/or after the removal process.

### CROSS-REFERENCE TO RELATED APPLICATIONS

This patent application is related to commonly owned co-pending U.S. patent application Ser. No. (SSI 05500) , filed ______, entitled “METHOD OF TREATING A COMPOSITE SPIN-ON GLASS/ANTI-REFLECTIVE MATERIAL PRIOR TO CLEANING”, U.S. patent application Ser. No. (SSI 06700) filed ______, entitled “ISOTHERMAL CONTROL OF A PROCESS CHAMBER”, U.S. patent application Ser. No. (SSI 10100) filed ______, entitled “NEUTRALIZATION OF SYSTEMIC POISONING IN WAFER PROCESSING”, U.S. patent application Ser. No. (SSI 10200) filed ______, entitled “ISOLATION GATE-VALVE FOR PROCESSING CHAMBER”, U.S. patent application Ser. No. (SSI 13400) , filed ______, entitled “METHOD OF INHIBITING COPPER CORROSION DURING SUPERCRITICAL CO₂ CLEANING”, U.S. patent application Ser. No. (SSI 05900) , filed ______, entitled “IMPROVED RINSING STEP IN SUPERCRITICAL PROCESSING”, U.S. patent application Ser. No. (SSI 05901) , filed ______, entitled “IMPROVED CLEANING STEP IN SUPERCRITICAL PROCESSING”, U.S. patent application Ser. No. (SSI 10800) , filed ______, entitled “ETCHING AND CLEANING BPSG MATERIAL USING SUPERCRITICAL PROCESSING”, U.S. patent application Ser. No. (SSI 10300) , filed ______, entitled “HIGH PRESSURE FOURIER TRANSFORM INFRARED CELL”, and U.S. patent application Ser. No. (SSI 09300) , filed ______, entitled “PROCESS FLOW THERMOCOUPLE”, which are hereby incorporated by reference in its entirety. This patent application is also related to commonly owned co-pending U.S. patent application Ser. No. 10/379,984, filed Mar. 3, 2003, entitled “Method of Passivating Low-K Dielectric Film” which is hereby incorporated by reference in its entirety.

### FIELD OF THE INVENTION

This invention relates to the field of processing porous low-k dielectric materials used in processing of semiconductor wafers. More particularly, the present invention relates to the field of processing porous low-k dielectric materials using supercritical carbon dioxide processes.

### BACKGROUND OF THE INVENTION

Carbon Dioxide (CO₂) is an environmentally friendly, naturally abundant, non-polar molecule. Being non-polar, CO₂ has the capacity to dissolve in and dissolve a variety of non-polar materials or contaminates. The degree to which the contaminants are soluble in non-polar CO₂ dependants on the physical state of the CO₂. The four phases of CO₂ are solid, liquid, gas, and supercritical. These states are differentiated by appropriate combinations of specific pressures and temperatures. CO₂ in a supercritical state (sc-CO₂) is neither liquid nor gas but embodies properties of both. In addition, sc-CO₂ lacks any meaningful surface tension while interacting with solid surfaces, and hence, can readily penetrate high aspect ratio geometrical features more readily than liquid CO₂. Moreover, because of its low viscosity and liquid-like characteristics, the sc-CO₂ can easily dissolve large quantities of many other chemicals. It has been shown that as the temperature and pressure are increased into the supercritical phase, the solvating properties of CO₂ also increases. This increase in the solvating properties of sc-CO₂ has lead to the development of a number of sc-CO₂ processes.

Porous, low-k dielectric materials commonly employ porogens to form the porous structure within the dielectric matrix. The porogens are generally polymeric spheres, which are distributed randomly through a silica-based dielectric matrix. After the dielectric has been cured, the porogens can be baked out. This bake-out process takes place at approximately 400 C and takes approximately 30 minutes. During the bake-out the polymeric molecules are thermally reduced to form volatile species, which are then carried out of the dielectric matrix leaving a porous dielectric structure.

What is needed is a method of and system for providing an improved method for removing porogen and porogen residues from a silica-based matrix.

### SUMMARY OF THE INVENTION

The present invention is directed to a method of and apparatus for processing a substrate having a patterned layer and/or dielectric layer thereon. In accordance with the method the substrate processing includes the steps of: positioning the substrate on a substrate holder in a processing chamber; performing a porogen removal process using a first supercritical fluid comprising supercritical CO₂ and a porogen removal chemistry; and performing a rinsing process using a second supercritical fluid comprising supercritical CO₂ and a rinsing chemistry.

### BRIEF DESCRIPTION OF THE DRAWINGS

A more complete appreciation of various embodiments of the invention and many of the attendant advantages thereof will become readily apparent with reference to the following detailed description, particularly when considered in conjunction with the accompanying drawings, in which:

FIG. 1 shows an exemplary block diagram of a processing system, in accordance with embodiments of the invention;

FIG. 2 illustrates an exemplary graph of pressure versus time for a supercritical process step, in accordance with an embodiment of the invention;

FIG. 3 illustrates a flow chart of a method of performing a supercritical porogen removal process on a substrate, in accordance with embodiments of the present invention; and

FIG. 4 illustrates a graph showing an exemplary process result, in accordance with an embodiment of the invention.

### DETAILED DESCRIPTION OF SEVERAL EMBODIMENTS

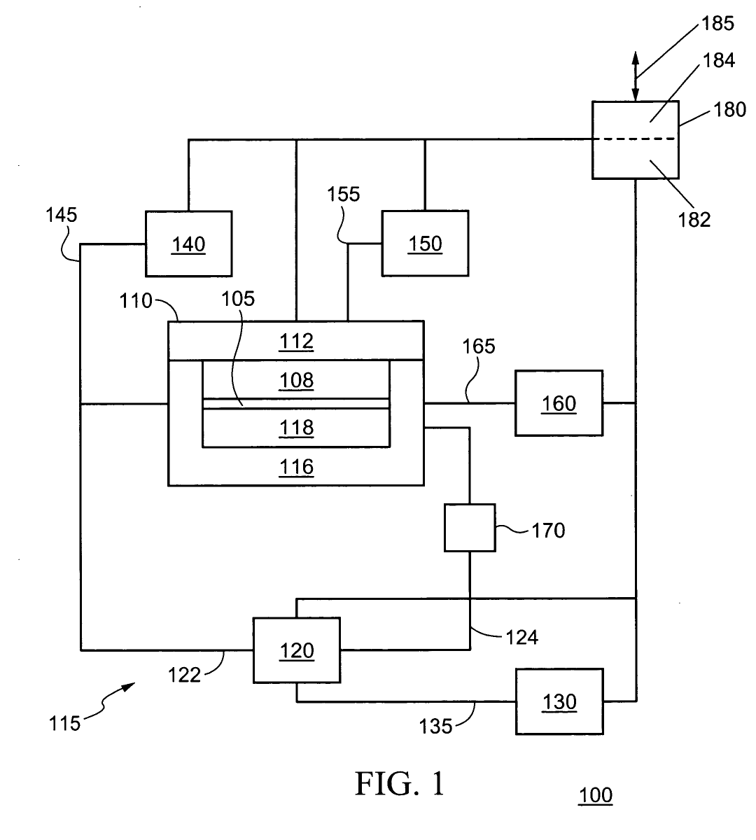

FIG. 1 shows an exemplary block diagram of a processing system 100 in accordance with embodiments of the invention. In the illustrated embodiment, processing system 100 comprises a process module 110, a recirculation system 120, a process chemistry supply system 130, a high-pressure fluid supply system 140, a pressure control system 150, an exhaust system 160, a monitoring system 170, and a controller 180. The processing system 100 can operate at pressures that can range from 1000 psi. to 10,000 psi. In addition, the processing system 100 can operate at temperatures that can range from 40 to 300 degrees Celsius.

The details concerning one example of a processing chamber are disclosed in co-owned and co-pending U.S. patent applications, Ser. No. 09/912,844, entitled “HIGH PRESSURE PROCESSING CHAMBER FOR SEMICONDUCTOR SUBSTRATE,” filed Jul. 24, 2004, Ser. No. 09/970,309, entitled “HIGH PRESSURE PROCESSING CHAMBER FOR MULTIPLE SEMICONDUCTOR SUBSTRATES,” filed Oct. 3, 2001, Ser. No. 10/121,791, entitled “HIGH PRESSURE PROCESSING CHAMBER FOR SEMICONDUCTOR SUBSTRATE INCLUDING FLOW ENHANCING FEATURES,” filed Apr. 10, 2002, and Ser. No. 10/364,284, entitled “HIGH-PRESSURE PROCESSING CHAMBER FOR A SEMICONDUCTOR WAFER,” filed Feb. 10, 2003, the contents of which are all incorporated herein by reference.

The controller 180 can be coupled to the process module 110, the recirculation system 120, the process chemistry supply system 130, the high-pressure fluid supply system 140, the pressure control system 150, and the exhaust system 160. Alternately, controller 180 can be coupled to one or more additional controllers/computers (not shown), and controller 180 can obtain setup, configuration, and/or recipe information from an additional controller/computer.

In FIG. 1, singular processing elements (110, 120, 130, 140, 150, 160, and 180) are shown, but this is not required for the invention. The semiconductor processing system 100 can comprise any number of processing elements having any number of controllers associated with them in addition to independent processing elements.

The controller 180 can be used to configure any number of processing elements (110, 120, 130, 140, 150, and 160), and the controller 180 can collect, provide, process, store, and display data from processing elements. The controller 180 can comprise a number of applications for controlling one or more of the processing elements. For example, controller 180 can include a graphical User Interface (GUI) component (not shown) that can provide easy to use interfaces that enable a user to monitor and/or control one or more processing elements.

The process module 110 can include an upper assembly 112 and a lower assembly 116, and the upper assembly 112 can be coupled to the lower assembly 116. In an alternate embodiment, a frame and or injection ring (not shown) may be included and may be coupled to an upper assembly 112 and a lower assembly 116. The upper assembly 112 can comprise a heater (not shown) for heating the process chamber 108, a substrate 105, a processing fluid, or any combination thereof. Alternately, a heater is not required in the upper assembly 112. In another embodiment, the lower assembly 116 can comprise a heater (not shown) for heating the process chamber 108, the substrate 105, the processing fluid, any combination thereof. The process module 110 can include means for flowing the processing fluid through the processing chamber 108. In one example, a circular flow pattern can be established, and in another example, a substantially linear flow pattern can be established. Alternately, the means for flowing can be configured differently. The lower assembly 116 can comprise one or more lifters (not shown) for moving a chuck 118 and/or the substrate 105. Alternately, a lifter is not required.

In one embodiment, the process module 110 can include a holder or chuck 118 for supporting and holding the substrate 105 while processing the substrate 105. The holder or chuck 118 can also be configured to heat or cool the substrate 105 before, during, and/or after processing the substrate 105. Alternately, the process module 110 can include a platen for supporting and holding the substrate 105 while processing the substrate 105.

A transfer system (not shown) can be used to move a substrate into and out of the processing chamber 108 through a slot (not shown). In one example, the slot can be opened and closed by moving the chuck 118, and in another example, the slot can be controlled using a gate valve (not shown).

The substrate 105 can include semiconductor material, metallic material, dielectric material, ceramic material, or polymeric material, or any combination thereof. The semiconductor material can include elements of Si, Ge, Si/Ge, or GaAs. The metallic material can include elements of Cu, Al, Ni, Pb, Ti, Ta, or W, or combinations of two or more thereof. The dielectric material can include elements of Si, O, N, or C, or combinations of two or more thereof. The ceramic material can include elements of Al, N, Si, C, or O, or combinations of two or more thereof.

The recirculation system 120 can be coupled to the process module 110 using one or more inlet lines 122 and one or more outlet lines 124. The recirculation system 120 can comprise one or more valves (not shown) for regulating the flow of a supercritical processing solution through the recirculation system and through the process module 110. The recirculation system 120 can comprise any number of back-flow valves, filters, pumps, and/or heaters (not shown) for maintaining a supercritical processing solution and flowing the supercritical process solution through the recirculation system 120 and through the processing chamber 108 in the process module 110.

In the illustrated embodiment, the chemistry supply system 130 is coupled to the recirculation system 120 using one or more lines 135, but this is not required for the invention. In alternate embodiments, the chemical supply system 130 can be configured differently and can be coupled to different elements in the processing system 100. For example, the chemistry supply system 130 can be coupled to the process module 110.

The process chemistry is preferably introduced by the process chemistry supply system 130 introduced into a fluid stream by the high-pressure fluid supply system 140 at ratios that vary with the substrate properties, the chemistry being used, and the process being performed in the processing module 110. The ratio can vary from approximately 0.001 to approximately 15 percent by volume. For example, when a recirculation loop 115 comprising the system components of the processing amber 108, the recirculation system 120 and lines 122 and 124 have a volume of about one liter, the process chemistry volumes can range from approximately ten micro liters to approximately one hundred fifty milliliters. In alternate embodiments, the volume and/or the ratio may be higher or lower.

The chemistry supply system 130 can comprise pre-treating chemistry assemblies (not shown) for providing pre-treating chemistry for generating supercritical pre-treating solutions within the processing chamber 108. The pre-treating chemistry can include a high polarity solvent. For example, supercritical carbon dioxide with one or more solvents, such as water or alcohols (such as IPA) can be introduced into the processing chamber 108.

The chemistry supply system 130 can comprise a rinsing chemistry assembly (not shown) for providing rinsing chemistry for generating supercritical rinsing solutions within the processing chamber 108. The rinsing chemistry can include one or more organic solvents including, but not limited to, alcohols and ketones. In one embodiment, the rinsing chemistry can comprise an alcohol and a carrier solvent. The chemistry supply system 130 can comprise a drying chemistry assembly (not shown) for providing drying chemistry for generating supercritical drying solutions within the processing chamber 108.

In addition, the process chemistry can include chelating agents, complexing agents, oxidants, organic acids, and inorganic acids that can be introduced into supercritical carbon dioxide with one or more carrier solvents, such as N,N-dimethylacetamide (DMAc), gamma-butyrolactone (BLO), dimethyl sulfoxide (DMSO), ethylene carbonate (EC), N-methylpyrrolidone (NMP), dimethylpiperidone, propylene carbonate, and alcohols (such a methanol, ethanol and 1-propanol).

Furthermore, the process chemistry can include solvents, co-solvents, surfactants, and/or other ingredients. Examples of solvents, co-solvents, and surfactants are disclosed in co-owned U.S. Pat. No. 6,500,605, entitled “REMOVAL OF PHOTORESIST AND RESIDUE FROM SUBSTRATE USING SUPERCRITICAL CARBON DIOXIDE PROCESS”, issued Dec. 31, 2002, and U.S. Pat. No. 6,277,753, entitled “REMOVAL OF CMP RESIDUE FROM SEMICONDUCTORS USING SUPERCRITICAL CARBON DIOXIDE PROCESS”, issued Aug. 21, 2001, both are incorporated by reference herein.

As shown in FIG. 1, the high-pressure fluid supply system 140 can be coupled to the recirculation system 120 using one or more lines 145, but this is not required. The inlet line 145 can be equipped with one or more back-flow valves, and/or heaters (not shown) for controlling the fluid flow from the high-pressure fluid supply system 140. In alternate embodiments, high-pressure fluid supply system 140 can be configured differently and coupled differently. For example, the high-pressure fluid supply system 140 can be directly coupled to the process module 110.

The high-pressure fluid supply system 140 can comprise a carbon dioxide source (not shown) and a plurality of flow control elements (not shown) for generating a supercritical fluid. For example, the carbon dioxide source can include a CO₂ feed system, and the flow control elements can include supply lines, valves, filters, pumps, and heaters. The high-pressure fluid supply system 140 can comprise an inlet valve (not shown) that is configured to open and close to allow or prevent the stream of supercritical carbon dioxide from flowing into the processing chamber 108. For example, controller 180 can be used to determine fluid parameters such as pressure, temperature, process time, and flow rate.

As shown in FIG. 1, the pressure control system 150 can be coupled to the process module 110 using one or more lines 155, but this is not required. Line 155 can be equipped with one or more back-flow valves, and/or heaters (not shown) for controlling the fluid flow to pressure control system 150. In alternate embodiments, pressure control system 150 can be configured differently and coupled differently. The pressure control system 150 can include one or more pressure valves (not shown) for exhausting the processing chamber 108 and/or for regulating the pressure within the processing chamber 108. Alternately, the pressure control system 150 can also include one or more pumps (not shown). For example, one pump may be used to increase the pressure within the processing chamber 108, and another pump may be used to evacuate the processing chamber 108. In another embodiment, the pressure control system 150 can comprise means for sealing the processing chamber 108. In addition, the pressure control system 150 can comprise means for raising and lowering the substrate 105 and/or the chuck 118.

As shown in FIG. 1, the exhaust control system 160 can be coupled to the process module 110 using one or more lines 165, but this is not required. Line 165 can be equipped with one or more back-flow valves, and/or heaters (not shown) for controlling the fluid flow to the exhaust control system 160. In alternate embodiments, exhaust control system 160 can be configured differently and coupled differently. The exhaust control system 160 can include an exhaust gas collection vessel (not shown) and can be used to remove contaminants from the processing fluid. Alternately, the exhaust control system 160 can be used to recycle the processing fluid.

In one embodiment, controller 180 can comprise a processor 182 and a memory 184. Memory 184 can be coupled to processor 182, and can be used for storing information and instructions to be executed by processor 182. Alternately, different controller configurations can be used. In addition, controller 180 can comprise a port 185 that can be used to couple processing system 100 to another system (not shown). Furthermore, controller 180 can comprise any number of input and/or output devices (not shown).

In addition, the one or more of the processing elements (110, 120, 130, 140, 150, 160, 170 and 180) can include memory (not shown) for storing information and instructions to be executed during processing and processors for processing information and/or executing instructions. For example, the memory may be used for storing temporary variables or other intermediate information during the execution of instructions by the various processors in the system. The one or more of the processing elements (110, 120, 130, 140, 150, 160, 170 and 180) can comprise the means for reading data and/or instructions from a computer readable medium. In addition, the one or more of the processing elements (110, 120, 130, 140, 150, 160, 170 and 180) can comprise the means for writing data and/or instructions to a computer readable medium.

Memory devices can include at least one computer readable medium or memory for holding computer-executable instructions programmed according to the teachings of the invention and for containing data structures, tables, records, or other data described herein. Controller 180 can use data from computer readable medium memory to generate and/or execute computer executable instructions. The processing system 100 can perform a portion of or all of the processing steps of the invention in response to the controller 180 executing one or more sequences of one or more computer-executable instructions contained in a memory. Such instructions may be received by the controller from another computer, a computer readable medium, or a network connection.

Stored on any one or on a combination of computer readable media, the present invention includes software for controlling the processing system 100, for driving a device or devices for implementing the invention, and for enabling the processing system 100 to interact with a human user and/or another system, such as a factory system. Such software may include, but is not limited to, device drivers, operating systems, development tools, and applications software. Such computer readable media further includes the computer program product of the present invention for performing all or a portion (if processing is distributed) of the processing performed in implementing the invention.

The term “computer readable medium” as used herein refers to any medium that participates in providing instructions to a processor for execution and/or that participates in storing information before, during, and/or after executing an instruction. A computer readable medium may take many forms, including but not limited to, non-volatile media, volatile media, and transmission media. The term “computer-executable instruction” as used herein refers to any computer code and/or software that can be executed by a processor, that provides instructions to a processor for execution and/or that participates in storing information before, during, and/or after executing an instruction.

Controller 180, processor 182, memory 184 and other processors and memory in other system elements can, unless indicated otherwise below, be constituted by components known in the art or constructed according to principles known in the art. The computer readable medium and the computer executable instructions can also, unless indicated otherwise below, be constituted by components known in the art or constructed according to principles known in the art.

Controller 180 can use the port 185 to obtain computer code and/or software from another system (not shown), such as a factory system. The computer code and/or software can be used to establish a control hierarchy. For example, the processing system 100 can operate independently, or can be controlled to some degree by a higher-level system (not shown).

The controller 180 can use data from one or more of the system components to determine when to alter, pause, and/or stop a process. The controller 180 can use the data and operational rules to determine when to change a process and how to change the process, and rules can be used to specify the action taken for normal processing and the actions taken on exceptional conditions. Operational rules can be used to determine which processes are monitored and which data is used. For example, rules can be used to determine how to manage the data when a process is changed, paused, and/or stopped. In general, rules allow system and/or tool operation to change based on the dynamic state of the system (100).

Controller 180 can receive, send, use, and/or generate pre-process data, process data, and post-process data, and this data can include lot data, batch data, run data, composition data, and history data. Pre-process data can be associated with an incoming substrate and can be used to establish an input state for a substrate and/or a current state for a process module. For example, pre-process data can be used to establish an input state for a wafer or substrate 105 that can include. Process data can include process parameters. Post processing data can be associated with a processed substrate.

Process data can include process parameters. Post processing data can be associated with a processed substrate and can be used to establish an output state for the processed substrate.

The controller 180 can use the pre-process data to predict, select, or calculate a set of process parameters to use to process the substrate 105. The pre-process data can include data describing the substrate 105 to be processed. For example, the pre-process data can include information concerning the substrate's materials, the number of layers, the materials used for the different layers, the thickness of materials in the layers, the size of vias and trenches, the amount/type of porogen, the amount/type of porogen residue, and a desired process result. The pre-process data can be used to determine a process recipe and/or process model. A process model can provide the relationship between one or more process recipe parameters and one or more process results. A process recipe can include a multi-step process involving a set of process modules. Post-process data can be obtained at some point after the substrate 105 has been processed. For example, post-process data can be obtained after a time delay that can vary from minutes to days.

The controller 180 can compute a predicted state for the substrate based on the pre-process data, the process characteristics, and a process model. For example, a treatment model can be used along with a material type and thickness to compute a predicted porogen removal time. In addition, a removal rate model can be used along with the type of porogen and/or residue amount to compute a processing time for a removal process.

In one embodiment, the substrate 105 can comprise at least one of a semiconductor material, a metallic material, a polysilicon material, low-k material, and process-related material. For example, the process-related material can include photoresist and/or photoresist residue, porogens and/or porogen residues. One process recipe can include steps for removing porogens and/or porogen residues from patterned or un-patterned low-k material. Another process recipe can include steps for cleaning, rinsing, removing porogens and/or porogen residues from the material, and sealing low-k material. Those skilled in the art will recognize that low-k material can include low-k and ultra-low-k material.

It will be appreciated that the controller 180 can perform other functions in addition to those discussed here. The controller 180 can monitor the pressure, temperature, flow, or other variables associated with the processing system 100 and take actions based on these values. For example, the controller 180 can process measured data, display data and/or results on a screen, determine a fault condition, determine a response to a fault condition, and alert an operator. The controller 180 can comprise a database component (not shown) for storing input and output data.

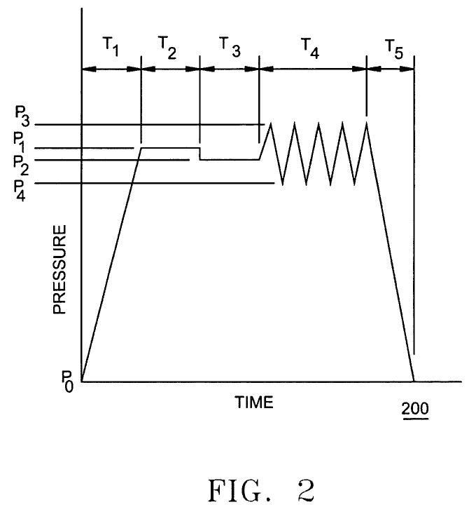

FIG. 2 illustrates an exemplary graph of pressure versus time for a supercritical process step in accordance with embodiments of the invention. In the illustrated embodiment, a graph 200 of pressure versus time is shown, and the graph 200 can be used to represent a supercritical treatment process step. Alternately, different pressures, different timing, and different sequences may be used for different processes. In addition, although a single time sequence is illustrated in FIG. 2, this is not required for the invention. Alternately, multi-sequence processes may be used.

Referring to both FIGS. 1 and 2, prior to an initial time T₀, the substrate 105 to be processed can be placed within the processing chamber 108 and the processing chamber 108 can be sealed. During a treatment process, a substrate 105 having porogens trapped within the dielectric material can be positioned in the chamber. In another embodiment, the substrate 105 may comprise residues such as porogen residues that can cause processing problems. The substrate 105, the processing chamber 108, and the other elements in the recirculation loop 115, such as the recirculation system 120 and the monitoring system 170, can be heated to an operational temperature. For example, the operational temperature can range from 40 to 300 degrees Celsius.

During time T₁, the processing chamber 108 and the other elements in the recirculation loop 115 can be pressurized. During at least one portion of the time T₁, the high-pressure fluid supply system 140 can be coupled into the flow path and can be used to provide temperature controlled carbon dioxide into the processing chamber 108 and/or other elements in the recirculation loop 115. For example, the temperature variation of the temperature-controlled carbon dioxide can be controlled to be less than approximately ten degrees Celsius during the pressurization process.

During time T₁, a pump (not shown) in the recirculation system 120 can be started and can be used to circulate the temperature controlled fluid through the monitoring system 170, the processing chamber 108, and the other elements in the recirculation loop 115.

During time T₁, process chemistry can be introduced. In one embodiment, when the pressure in the processing chamber 108 exceeds a critical pressure Pc (1,070 psi), process chemistry can be injected into the processing chamber 108, using the process chemistry supply system 130. For example, the injection(s) of the process chemistries can begin upon reaching about 1100-1200 psi. In alternate embodiments, process chemistry may be injected into the processing chamber 108 before the pressure exceeds the critical pressure Pc (1,070 psi) using the process chemistry supply system 130. In other embodiments, process chemistry is not injected during a first time T₁.

In one embodiment, the high-pressure fluid supply system 140 can be switched off before the, process chemistry is injected. Alternately, the high-pressure fluid supply system 140 can be switched on while the process chemistry is injected.

Process chemistry can be injected in a linear fashion, and the injection time can be based on a recirculation time. For example, the recirculation time can be determined based on the length of the recirculation path and the flow rate. In other embodiments, process chemistry may be injected in a non-linear fashion. For example, process chemistry can be injected in one or more steps.

The process chemistry can include a cleaning agent, a rinsing agent, or a curing agent, or a combination thereof that is injected into the supercritical fluid. One or more injections of process chemistries can be performed over the duration of time T₁ to generate a supercritical processing solution with the desired concentrations of chemicals. The process chemistry, in accordance with the embodiments of the invention, can also include one more or more carrier solvents, such as IPA.

Still referring to both FIGS. 1, and 2, during a second time T₂, the supercritical processing solution can also be re-circulated over the substrate and through the processing chamber 108 using the recirculation system 120, such as described above. In one embodiment, process chemistry is not injected during the second time T₂. Alternatively, process chemistry may be injected into the processing chamber 108 before the second time T₂ or after the second time T₂.

In one embodiment, the process chemistry used during one or more steps in a porogen removal process can include a high polarity solvent. Solvents, such as alcohols and water, can be used. In another embodiment, the process chemistry used can include alcohol, an acid, and/or water.

The processing chamber 108 can operate at a first pressure P₁ above 1,500 psi during the second time T₂. For example, the pressure can range from approximately 2,500 psi to approximately 3,100 psi, but can be any value so long as the operating pressure is sufficient to maintain supercritical conditions. The supercritical processing solution can be recirculated over the substrate 105 and through the recirculation loop 115. The supercritical conditions within the processing chamber 108 and the other elements in the recirculation loop 115 are maintained during the second time T₂, and the supercritical processing solution continues to be circulated over the substrate and through the processing chamber 108 and the other elements in the recirculation loop 115. The recirculation system 120 can be used to regulate the flow of the supercritical processing solution through the processing chamber 108 and the other elements in the recirculation loop 115.

In one embodiment, during time T₂, the pressure can be substantially constant. Alternately, the pressure may have different values during different portions of time T₂.

In one embodiment, the process chemistry used during one or more steps in a porogen removal process can be injected at a pressure above approximately 2200 psi and circulated at a pressure above approximately 2700 psi. In an alternate embodiment, the process chemistry used during one or more steps in a porogen removal process can be injected at a pressure above approximately 2500 psi and circulated at a pressure above approximately 2500 psi.

Still referring to both FIGS. 1 and 2, during a third time T₃, one or more push-through processes can be performed. In an alternate embodiment, a push-through process may not be required after each porogen removal step. During the third time T₃, a new quantity of supercritical carbon dioxide can be fed into the processing chamber 108 and the other elements in the recirculation loop 115 from the high-pressure fluid supply system 140, and the supercritical porogen removal solution along with process residue suspended or dissolved therein can be displaced from the processing chamber 108 and the other elements in the recirculation loop 115 through the exhaust control system 160. In an alternate embodiment, supercritical carbon dioxide can be fed into the recirculation system 120 from the high-pressure fluid supply system 140, and the supercritical porogen removal solution along with process residue suspended or dissolved therein can be displaced from the processing chamber 108 and the other elements in the recirculation loop 115 through the exhaust control system 160. For example, the process residue may include porogen residues.

The high-pressure fluid supply system 140 can comprise means for providing a first volume of temperature-controlled fluid during a push-through process, and the first volume can be larger than the volume of the recirculation loop 115. Alternately, the first volume can be less than or approximately equal to the volume of the recirculation loop 115. Providing temperature-controlled fluid during the push-through process prevents process residue suspended or dissolved within the fluid being displaced from the processing chamber 108 and the other elements in the recirculation loop 115 from dropping out and/or adhering to the processing chamber 108 and the other elements in the recirculation loop 115. In addition, during the third time T₃, the temperature of the fluid supplied by the high-pressure fluid supply system 140 can vary over a wider temperature range than the range used during the second time T₂.

In the illustrated embodiment shown in FIG. 2, a single second time T₂ is followed by a single third time T₃, but this is not required. In alternate embodiments, other time sequences may be used to process the substrate 105. In addition, during the second time T₂, the pressure P₁ can be higher than a second pressure P₂ during the third time T₃. Alternatively, the first pressure P₁ and the second pressure P₂ may have different values.

During a fourth time T₄, a pressure cycling process can be performed. In an alternate embodiment, a pressure cycling process is not required. During the fourth time T₄, the processing chamber 108 can be cycled through a plurality of decompression and compression cycles. The pressure can be cycled between a third pressure P₃ and a fourth pressure P₄ one or more times. In alternate embodiments, the third pressure P₃ and the fourth pressure P₄ can vary. In one embodiment, the pressure can be lowered by venting through the exhaust control system 150. For example, this can be accomplished by lowering the pressure to below approximately 1,500 psi and raising the pressure to above approximately 2,500 psi. The pressure can be increased by using the high-pressure fluid supply system 140 to provide additional high-pressure fluid.

The high-pressure fluid supply system 140 can comprise means for providing a first volume of temperature-controlled fluid during a compression cycle, and the first volume can be larger than the volume of the recirculation loop 115. Alternately, the first volume can be less than or approximately equal to the volume of the recirculation loop 115. In addition, the temperature differential within the first volume of temperature-controlled fluid during the compression cycle can be controlled to be less than approximately ten degrees Celsius. In addition, the high-pressure fluid supply system 140 can comprise means for providing a second volume of temperature-controlled fluid during a decompression cycle, and the second volume can be larger than the volume of the recirculation loop 115. Alternately, the second volume can be less than or approximately equal to the volume of the recirculation loop 115. In addition, the temperature differential within the second volume of temperature-controlled fluid during the decompression cycle can be controlled to be less than approximately twenty degrees Celsius. Alternately, the temperature variation of the temperature-controlled fluid can be controlled to be less than approximately ten degrees Celsius during a decompression cycle.

For example, during the fourth time T₄, one or more volumes of temperature controlled supercritical carbon dioxide can be fed into the processing chamber 108 and the other elements in the recirculation loop 115 from the high-pressure fluid supply system 140, and the supercritical processing solution along with process residue suspended or dissolved therein can be displaced from the processing chamber 108 and the other elements in the recirculation loop 115 through the exhaust control system 150. Providing temperature-controlled fluid during the decompression process prevents process residue suspended or dissolved within the fluid being displaced from the processing chamber 108 and the other elements in the recirculation loop 115 from dropping out and/or adhering to the processing chamber 108 and the other elements in the recirculation loop 115. In addition, during the fourth time T₄, the temperature of the fluid supplied by the high-pressure fluid supply system 140 can vary over a wider temperature range than the range used during the second time T₂.

In the illustrated embodiment shown in FIG. 2, a single third time T₃ is followed by a single fourth time T₄, but this is not required. In alternate embodiments, other time sequences may be used to process a substrate.

In an alternate embodiment, the high-pressure fluid supply system 140 can be switched off during a portion of the fourth time T₄. For example, the high-pressure fluid supply system 140 can be switched off during a decompression cycle.

In one embodiment, a porogen removal process can be performed followed by at least three decompression cycles when processing dielectric material. In an alternate embodiment, one or more decompression cycles may be used after a porogen removal process.

During a fifth time T₅, the processing chamber 108 can be returned to lower pressure. For example, after the pressure cycling process is completed, then the processing chamber 108 can be vented or exhausted to a pressure compatible with a transfer system

In one embodiment, the monitoring system 170 (FIG. 1) can operate during a venting process. Alternately, the monitoring system 170 may not be operated during a venting process. The monitoring system 170 can be used to control the chemical composition during a venting process. The high-pressure fluid supply system 140 can comprise means for providing a volume of temperature-controlled fluid during a venting process, and the volume can be larger than the volume of the recirculation loop 115. Alternately, the volume can be less than or approximately equal to the volume of the recirculation loop 115. For example, during the fifth time T₅, one or more volumes of temperature controlled supercritical carbon dioxide can be fed into the processing chamber 108 and the other elements in the recirculation loop 115 from the high-pressure fluid supply system 140, and the remaining processing solution along with process residue suspended or dissolved therein can be displaced from the processing chamber 108 and the other elements in the recirculation loop 115 through the exhaust control system 160. The monitoring system 170 can be used to measure the process residue in the processing solution before, during, and/or after a venting process.

In the illustrated embodiment shown in FIG. 2, a single fourth time T₄ is followed by a single fifth time T₅, but this is not required. In alternate embodiments, other time sequences may be used to process a substrate.

In one embodiment, during a portion of the fifth time T₅, the high-pressure fluid supply system 140 can be switched off. In addition, the temperature of the fluid supplied by the high-pressure fluid supply system 140 can vary over a wider temperature range than the range used during the second time T₂. For example, the temperature can range below the temperature required for supercritical operation.

For substrate processing, the chamber pressure can be made substantially equal to the pressure inside of a transfer chamber (not shown) coupled to the processing chamber. In one embodiment, the substrate can be moved from the processing chamber 108 into the transfer chamber, and moved to a second process apparatus or module (not shown) to continue processing.

In the illustrated embodiment shown in FIG. 2, the pressure returns to an initial pressure P₀, but this is not required for the invention. In alternate embodiments, the pressure does not have to return to P₀, and the process sequence can continue with additional time steps such as those shown in time steps corresponding to T₁, T₂, T₃, T₄, or T₅. In one embodiment, a porogen removal process time can be less than about three minutes. Alternately, the porogen removal process time may vary from approximately ten seconds to approximately ten minutes.

The graph 200 is provided for exemplary purposes only. It will be understood by those skilled in the art that a supercritical processing step can have any number of different time/pressures or temperature profiles without departing from the scope of the invention. Further, any number of cleaning, rinsing, and/or curing process sequences with each step having any number of compression and decompression cycles are contemplated. In addition, as stated previously, concentrations of various chemicals and species within a supercritical processing solution can be readily tailored for the application at hand and altered at any time within a supercritical processing step.

For example, process steps can be repeated a number of times to achieve a desired process result, and a unique process recipe can be established for each different combination of the process steps. A process recipe can be used to establish the process parameters used during the different process recipes to remove different porogens. In addition, the process parameters can be different during the different process steps based on the type of porogen removal being performed. For example, a process recipe established for extracting one type of porogen and/or porogen residue from a substrate from one manufacturing line can be different from the process recipe established for extracting another type of porogen and/or porogen residue from a different substrate from a different manufacturing line.

In addition, additional processing steps can be performed after a porogen removal process is performed. For example, a pore sealing, a k-value restoration, a rinsing process, a cleaning process, or a drying process, or a combination thereof can be performed. These additional processes may require other processing chemistry to be circulated within the processing chamber. For example, the removal chemistry can include alcohol and water, and the rinsing chemistry does not include water. Alternately, drying steps may be included.

In another embodiment, the controller 180 can use historical data and/or process models to compute an expected value for the temperature of the fluid at various times during the process. The controller 180 can compare an expected temperature value to a measured temperature value to determine when to alter, pause, and/or stop a process.

In a supercritical process, the desired process result can be a process result that is measurable using an optical measuring device, such as a Scanning Electron Microscopy (SEM) and/or Transmission Electron Microscopy (TEM). For example, the desired process result can be an amount of residue and/or contaminant in a via or on the surface of a substrate. After one or more processing steps, the desired process can be measured.

In one embodiment, the desired process result can be a process result that is measurable using Fourier Transform Infrared Spectroscopy (FTIR) which is an analytical technique used to identify materials. The FTIR technique measures the absorption of various infrared light wavelengths by the material of interest. These infrared absorption bands identify specific molecular components and structures. The absorption bands in the region between 1500-400 wave numbers are generally due to intra-molecular phenomena, and are highly specific for each material. The specificity of these bands allows computerized data searches to be performed against reference libraries to identify a material and/or identify the presence of a material.

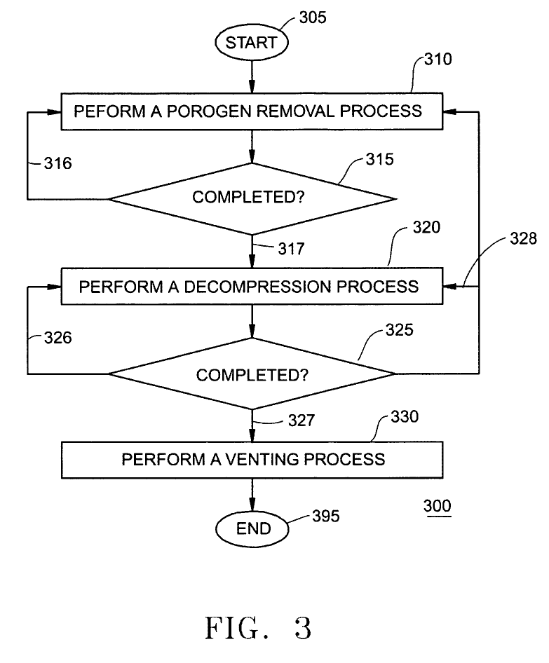

FIG. 3 illustrates a flow chart of a method of performing a supercritical porogen removal process on a substrate in accordance with embodiments of the present invention. Procedure 300 can start at the step 305.

Referring to FIGS. 1-3, the substrate 105 to be processed can be placed within the processing chamber 108 and the processing chamber 108 can be sealed. During a supercritical porogen removal process 300, the substrate 105 being processed can comprise semiconductor material, low-k dielectric material, metallic material, porogen material, and can have porogen residue thereon. The substrate 105, the processing chamber 108, and the other elements in the recirculation loop 115 can be heated to an operational temperature. For example, the operational temperature can range from approximately 40 degrees Celsius to approximately 300 degrees Celsius. In some examples, the temperature can range from approximately 80 degrees Celsius to approximately 150 degrees Celsius.

In addition, the processing chamber 108 and the other elements in the recirculation loop 115 can be pressurized. For example, a supercritical fluid, such as substantially pure CO₂, can be used to pressurize the processing chamber 108 and the other elements in the recirculation loop 115. A pump (not shown), can be used to circulate the supercritical fluid through the processing chamber 108 and the other elements in the recirculation loop 115.

In 310, a porogen removal process can be performed. In one embodiment, a supercritical porogen removal process can be performed. Alternately, a non-supercritical porogen removal process can be performed. In one embodiment, a supercritical porogen removal process 310 can include recirculating the porogen removal chemistry within the processing chamber 108. Recirculating the porogen removal chemistry over the substrate 105 within the processing chamber 108 can comprise recirculating the porogen removal chemistry for a period of time to remove one or more porogen materials and/or residues from the substrate.

In one embodiment, one or more push-through steps can be performed as a part of the porogen removal process. During a push-through step, a new quantity of supercritical carbon dioxide can be fed into the processing chamber 108 and the other elements in the recirculation loop 115 from the high-pressure fluid supply system 140, and the supercritical porogen removal solution along with the process byproducts suspended or dissolved therein can be displaced from the processing chamber 108 and the other elements in the recirculation loop 115 through the exhaust control system 160. In another embodiment, supercritical carbon dioxide can be fed into the recirculation system 120 from the high-pressure fluid supply system 140, and the supercritical porogen removal solution along with process byproducts suspended or dissolved therein can also be displaced from the processing chamber 108 and the other elements in the recirculation loop 115 through the exhaust control system 160. In an alternate embodiment, a push-through step is not required during a cleaning step. For example, process byproducts can include porogen materials and/or residues.

In one embodiment, dielectric material can be processed and one or more porogens can be removed from the low-k dielectric material using process chemistry that includes one or more alcohols and one or more solvents.

In 315, a query is performed to determine when the porogen removal process has been completed. When the porogen removal process is completed, procedure 300 can branch 317 to 320 and continues. When the porogen removal process is not completed, procedure 300 branches back 316 to 310 and the porogen removal process continues. One or more extraction steps can be performed during a porogen removal process. For example, different chemistries, different concentrations, different process conditions, and/or different times can be used in different porogen removal process steps.

In 320, a decompression process can be performed while maintaining the processing system in a supercritical state. In one embodiment, a two-pressure process can be performed in which the two pressures are above the critical pressure. Alternately, a multi-pressure process can be performed. In another embodiment, a decompression process is not required. During a decompression process, the processing chamber 108 can be cycled through one or more decompression cycles and one or more compression cycles. The pressure can be cycled between a first pressure and a second pressure one or more times. In alternate embodiments, the third pressure P₃ and/or a fourth pressure P₄ can vary. In one embodiment, the pressure can be lowered by venting through the exhaust control system 160. For example, this can be accomplished by lowering the pressure to below approximately 2,500 psi and raising the pressure to above approximately 2,500 psi. The pressure can be increased by adding high-pressure carbon dioxide.

In 325, a query is performed to determine when the decompression process 320 has been completed. When the decompression process is completed, procedure 300 can branch 327 to 330, and procedure 300 can continue on to step 330 if no additional porogen removal steps are required. When the decompression process is completed and additional porogen removal steps are required, procedure 300 can branch 328 back to 310, and procedure 300 can continue by performing additional porogen removal steps as required.

When the decompression process is not completed, procedure 300 can branch back 326 to 320 and the decompression process continues. One or more pressure cycles can be performed during a decompression process. For example, different chemistries, different concentrations, different process conditions, and/or different times can be used in different pressure steps.

In one embodiment, three to six decompression and compression cycles can be performed after the porogen removal process is performed.

In 330, a venting process can be performed. In one embodiment, a variable pressure venting process can be performed. Alternately, a multi-pressure venting process can be performed. During a venting process, the pressure in the processing chamber 108 can be lower to a pressure that is compatible with a transfer system pressure. In one embodiment, the pressure can be lowered by venting through the exhaust control system 160.

Procedure 300 ends in 395.

After a porogen removal process has been performed, a k-value restoration process, or a pore sealing process, or a combination process can be performed.

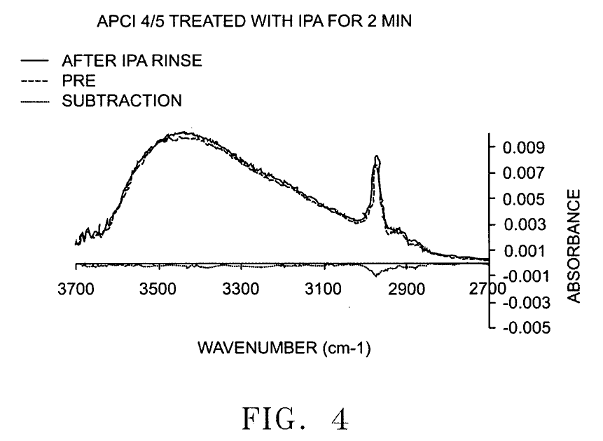

FIG. 4 illustrates a graph showing an exemplary process result in accordance with an embodiment of the invention. In the illustrated embodiment, a two-minute process is shown but this is not required. Alternately, other processing times and other process chemistries may be used.

FIG. 4 shows the Fourier-transform infrared spectroscopy results for pre and post process conditions. Absorbance is shown as the measured quantity and these units can be used to measure the amount of infrared radiation absorbed by a sample. Absorbance is commonly used as the Y-axis in infrared spectra. Absorbance is defined by Beer's Law, and is linearly proportional to concentration. This is why spectra plotted in absorbance units should be used in quantitative analysis. The graph illustrates an Infrared Spectrum and is a plot of measured infrared intensity versus wave number. The features in an infrared spectrum correlate with the presence of functional groups in a molecule, which is why infrared spectra can be interpreted to determine and/or identify a molecular structure and/or material type.

While the invention has been described in terms of specific embodiments incorporating details to facilitate the understanding of the principles of construction and operation of the invention, such reference herein to specific embodiments and details thereof is not intended to limit the scope of the claims appended hereto. It will be apparent to those skilled in the art that modifications may be made in the embodiments chosen for illustration without departing from the spirit and scope of the invention.

What is claimed is:

1. A method of processing a substrate having a patterned dielectric layer thereon, the method comprising the steps of:
positioning the substrate on a substrate holder in a processing chamber; and
performing a porogen removal process using a first supercritical fluid comprising supercritical CO₂ and a porogen removal chemistry.

2. The method of claim 1, wherein the substrate comprises semiconductor material, metallic material, dielectric material, or ceramic material, or a combination of two or more thereof.

3. The method of claim 2, wherein the dielectric layer comprises a low-k material, or ultra low-k material, or a combination thereof.

4. The method of claim 1, wherein the porogen removal chemistry comprises a polar solvent and a co-solvent.

5. The method of claim 4, wherein the polar solvent comprises an alcohol.

6. The method of claim 5, wherein the polar solvent comprises IPA.

7. The method of claim 1, wherein the porogen removal chemistry comprises a polar solvent, or an acid, or a combination thereof.

8. The method of claim 7, wherein the polar solvent comprises an alcohol.

9. The method of claim 8, wherein the polar solvent comprises IPA.

10. The method of claim 7, wherein the acid is selected from a group consisting of acetic acid, oxalic acid, and combinations thereof.

11. The method of claim 1, further comprising performing a rinsing process using a second supercritical fluid comprising supercritical CO₂ and a rinsing chemistry, wherein the rinsing chemistry comprises an alcohol.

12. The method of claim 11, wherein the alcohol comprises ethanol, methanol, or isopropyl, or a combination thereof.

13. The method of claim 11, wherein the alcohol comprises IPA.

14. The method of claim 1, wherein the step of performing a porogen removal process comprises:
pressurizing the processing chamber to a first pressure;
introducing the first supercritical fluid into the processing chamber;
changing the processing chamber pressure to a second pressure; and
recirculating the first supercritical fluid within the processing chamber for a first period of time.

15. The method of claim 14, wherein the second pressure is equal to or greater than the first pressure.

16. The method of claim 15, wherein the first pressure is below approximately 2700 psi and the second pressure is above approximately 2700 psi.

17. The method of claim 14, wherein the second pressure is less than the first pressure.

18. The method of claim 14, wherein the first period of time is in a range of thirty seconds to ten minutes.

19. The method of claim 14, wherein the step of performing a porogen removal process further comprises performing a series of decompression cycles.

20. The method of claim 19, wherein the step of performing a series of decompression cycles comprises performing one-to-six decompression cycles.

21. The method of claim 14, wherein the step of performing a porogen removal process further comprises performing a push-through process wherein the processing chamber is pressurized to an elevated pressure and vented to push the porogen removal chemistry out of the processing chamber after recirculating the porogen removal chemistry.

22. The method of claim 21, wherein the elevated pressure is above approximately 3000 psi.

23. The method of claim 11, wherein the step of performing a rinsing process comprises the steps of:
pressurizing the processing chamber to a third pressure;
introducing the second supercritical fluid into the processing chamber; and
recirculating the second supercritical fluid within the processing chamber for a second period of time.

24. The method of claim 23, wherein the second period of time is in a range of thirty seconds to ten minutes.

25. The method of claim 23, wherein the step of performing a rinsing process further comprises performing a series of decompression cycles.

26. The method of claim 25, wherein the step of performing a series of decompression cycles comprises performing one-to-six decompression cycles.

27. The method of claim 23, wherein the step of step of performing a rinsing process further comprises performing a push-through process wherein the processing chamber is pressurized to an elevated pressure to push the rinsing chemistry out of the processing chamber after recirculating the rinsing chemistry within the processing chamber.

28. The method of claim 27, wherein the elevated pressure is above approximately 3000 psi.

29. The method of claim 1, further comprising:
pressurizing the processing chamber to a first cleaning pressure;
introducing a cleaning chemistry into the processing chamber; and
recirculating the cleaning chemistry within the processing chamber.

30. The method of claim 29, further comprises performing a series of decompression cycles after recirculating the cleaning chemistry.

31. The method of claim 29, further comprises performing a push-through process wherein the processing chamber is pressurized to an elevated pressure to push the cleaning chemistry out of the processing chamber after recirculating the cleaning chemistry.

32. The method of claim 31, further comprises performing a series of decompression cycles after performing a push-through process.

33. The method of claim 1, further comprising the step of performing an additional process after performing the rinsing process.

34. The method of claim 33, wherein the additional process comprises a drying step, a rinsing step, a cleaning step, a push-through step, a decompression cycle, or an etching step, or a combination of two or more thereof.

35. The method of claim 1 further comprising the step of venting the processing chamber after performing the rinsing process.
